(19) United States
(12) Patent Application Publication
(10) Pub. No.: US 2025/0005372 A1
(43) Pub. Date: Jan. 2, 2025

(54) TRANSFER LEARNING FOR GENERATING A TARGET DOMAIN ANOMALY DETECTION MODEL USING SOURCE DOMAIN DATA

(71) Applicant: International Business Machines Corporation, Armonk, NY (US)

(72) Inventors: Takayuki Katsuki, Tokyo (JP); Haoxiang Qiu, Tokyo (JP); Tadanobu Inoue, Yokohama (JP)

(21) Appl. No.: 18/342,764

(22) Filed: Jun. 28, 2023

(51) Int. Cl. G06N 3/096

(52) U.S. Cl. CPC G06N 3/096

(57) ABSTRACT

Embodiments of the invention are directed to a computer system including a memory communicatively coupled to a processor system, where the processor system is operable to perform processor system operations to predict an anomaly in a target domain (TD) dataset. The processor system operations include training a model to perform an anomaly prediction task on a TD. The training includes applying a transfer learning operation that includes learning to predict the anomaly based at least in part on a first source domain (SD) precision matrix computed from a first SD.

### BACKGROUND

The present invention relates in general to programmable computers that prepare digital information for analysis. More specifically, the present invention relates to computing systems, computer-implemented methods, and computer program products that implement a novel transfer learning scheme operable to generate a target domain anomaly detection model using source domain data.

Data science combines math, statistics, specialized programming, advanced analytics, artificial intelligence (AI), and machine learning (ML), and specific subject matter expertise to uncover actionable insights hidden in an organization's data. The insights can be used to guide decision making and strategic planning. An important consideration in data science is the quality of the data to be analyzed. Data quality can be impacted by so-called “anomaly” or “outlier” data. The term “anomaly” refers to a data point or a set of data points that diverges dramatically from expected samples and patterns for their type. For a dataset that follows a standard bell curve, the anomalies are the data on the far right and left. Anomalies can indicate fraud or some other anomaly, but they can also be measurement errors, experimental problems, or a novel, one-off instance. Anomalies and/or outliers can hamper data analysis techniques and skew analysis results.

Anomaly detection is the process of detecting anomalies, and, depending on the goals of the associated data analysis, remove or resolve them from the analysis to prevent any potential skewing. For image domains, anomaly detection processes can be used in quality control operations to inspect surfaces to identify unacceptable defects or imperfections in an associated product. Anomaly detection uses mathematical techniques to detect abnormalities within a dataset (e.g., a dataset that represents an image) based on how different a given data point is from its surrounding data points or from a standard deviation. Anomaly detection tasks can be performed by neural networks using deep learning algorithms. Known deep learning algorithms generally require large amounts of labeled (annotated) data to learn so-called “deep features” in order to train effective models for the performance of cognitive operations such as prediction, classification, and the like. However, in many anomaly detection deep learning applications, labeled anomalous training data is not available or not abundant due to a variety of factors.

So-called “zero-shot” learning techniques have been developed to train machine learning algorithms to perform classification and/or prediction tasks where the machine learning algorithm has not previously seen or been trained with examples of the actual classification/prediction task. In other words, zero-shot learning can enable a machine algorithm to perform classification/prediction tasks where examples of the actual to-be-predicted (TBP) data are “unknown” to the machine learning algorithm(s). TBP data can include content-related features and domain-related features. In an example where the classification task is classifying anomalous sounds (e.g., sounds that indicate an actual or eminent vehicle malfunction) coming from a vehicle, the characteristics of the acoustic sound (e.g., pitch, tone, loudness, etc.) are considered the “content” features of the TBP data; and the context characteristics of the runtime acoustic sound (vehicle make/model, weather, road conditions, driving habits of the vehicle operator, driving through tunnels, etc.) are considered the “domain” features of the TBP data. In this detailed description, the term “unknown” refers to situations where training data of the content and domain in which a neural network will attempt to classify TBP data is not available in sufficient quantities for effective training of a deep learning neural network.

In zero-shot learning, the classes covered by training instances and the classes that the classification/prediction task needs to classify are disjoint. Thus, zero-shot learning techniques are designed to overcome the lack of training examples in the classification/prediction task by leveraging details learned from training examples of a task that is related to but different from the subject classification/prediction task. The details learned from training examples of the related/different task are used to draw inferences about the unknown classes of the subject classification/prediction task because both the training classes and the unknown task classes are related in a high dimensional vector space called semantic space. Thus, known zero-shot learning techniques can include a training stage and an inference stage. In the training stage, knowledge about the attributes of intermediate semantic layers is captured; and in the inference stage, this knowledge is used to categorize instances among a new set of classes.

Another machine learning technique for performing zero-shot learning is known as “transfer learning.” Transfer learning is a machine learning method where a model developed for a first task is reused as the starting point for a model on a second, different but related task. For example, in a deep learning application, pre-trained models are used as the starting point on a variety of computer vision and natural language processing tasks. Transfer learning leverages through reuse the vast knowledge, skills, computer, and time resources required to develop neural network models. Transfer learning techniques have been developed that leverage training data from a different but related domain in an attempt to avoid the significant amount of time it takes to develop labeled training data to train an anomaly detection model for a performing anomaly detection tasks in a subject domain. The domain of the TBP data is referred to as the target domain (TD), and the domain of the different but related task is referred to as the source domain (SD).

It is a challenge in known zero-shot deep learning techniques that implement transfer learning to identify the deep features of the TD in a manner that enables the SD training data to train the TD anomaly detection model in an efficient and effective manner. Accordingly, there is a need in the art of anomaly detection to develop processes for identifying deep features of the TD in manner that enables zero-shot deep learning processes and transfer learning processes to efficiently and effectively leverage SD training data to develop TD anomaly detection models.

### SUMMARY

Embodiments of the invention are directed to a computer system including a memory communicatively coupled to a processor system, where the processor system is operable to perform processor system operations to predict an anomaly in a target domain (TD) dataset. The processor system operations include training a model to perform an anomaly prediction task on a TD. The training includes applying a transfer learning operation that includes learning to predict the anomaly based at least in part on a first source domain (SD) precision matrix computed from a first SD.

The above-described embodiments of the invention provide technical benefits and technical effects. While known deep feature approaches do not allow the TD domain vector to be input into their computation of anomaly prediction, i.e., the computation of the anomaly Mahalanobis distance, as an additional input because the input format is fixed in known deep feature approaches, embodiments of the invention use a first SD precision matrix to compute the anomaly sore. The approach used in embodiments of the invention can bypass the above-described limitations of known deep feature approaches because embodiments of the invention do not change the input format but change the parameters in the computation of the anomaly prediction, i.e., the first SD precision matrix.

In addition to one or more of the features described above, or as an alternative to any of the foregoing embodiments of the invention, learning to predict the anomaly is further based at least in part on a second SD precision matrix computed from a second SD that is different from the first SD.

The above-described embodiments of the invention provide technical benefits and technical effects. While known deep feature approaches do not allow the TD domain vector to be input into their computation of anomaly prediction, i.e., the computation of the anomaly Mahalanobis distance, as an additional input because the input format is fixed in known deep feature approaches, embodiments of the invention use a first SD precision matrix and a second precision matrix to compute the anomaly sore. The approach used in embodiments of the invention can bypass the above-described limitations of known deep feature approaches because embodiments of the invention do not change the input format but change the parameters in the computation of the anomaly prediction, i.e., the first SD precision matrix and the second SD precision matrix, where the first and second SDs are different from one another.

In addition to one or more of the features described above, or as an alternative to any of the foregoing embodiments of the invention, learning to predict the anomaly is further based at least in part on a first SD mean vector computed from the first SD.

The above-described embodiments of the invention provide technical benefits and technical effects. While known deep feature approaches do not allow the TD domain vector to be input into their computation of anomaly prediction, i.e., the computation of the Mahalanobis distance, as an additional input because the input format is fixed in known deep feature approaches, embodiments of the invention use a first SD mean vector, a first SD precision matrix and a second precision matrix to compute the anomaly sore. The approach used in embodiments of the invention can bypass the above-described limitations of known deep feature approaches because embodiments of the invention do not change the input format but change the parameters in the computation of the anomaly prediction, i.e., the first SD mean vector, the first SD precision matrix, and the second SD precision matrix, where the first and second SDs are different from one another.

In addition to one or more of the features described above, or as an alternative to any of the foregoing embodiments of the invention, learning to predict the anomaly is further based at least in part on a second SD mean vector computed from the second SD.

The above-described embodiments of the invention provide technical benefits and technical effects. While known deep feature approaches do not allow the TD domain vector to be input into their computation of anomaly prediction, i.e., the computation of the Mahalanobis distance, as an additional input because the input format is fixed in known deep feature approaches, embodiments of the invention use a first SD mean vector, a second SD mean vector, a first SD precision matrix and a second precision matrix to compute the anomaly sore. The approach used in embodiments of the invention can bypass the above-described limitations of known deep feature approaches because embodiments of the invention do not change the input format but change the parameters in the computation of the anomaly prediction, i.e., the first SD mean vector, the second SD mean vector, the first SD precision matrix, and the second SD precision matrix, where the first and second SDs are different from one another.

In addition to one or more of the features described above, or as an alternative to any of the foregoing embodiments of the invention, learning to predict the anomaly is further based at least in part on a first summation including a summation of the first SD precision matrix and the second SD precision matrix; and a second summation including a summation of the first SD mean vector and the second SD mean vector.

The above-described embodiments of the invention provide technical benefits and technical effects. While known deep feature approaches do not allow the TD domain vector to be input into their computation of anomaly prediction, i.e., the computation of the Mahalanobis distance, as an additional input because the input format is fixed in known deep feature approaches, embodiments of the invention use a first summation that includes a summation of the first SD mean vector and the second SD mean vector, along with a second summation that includes a summation of the first SD precision matrix and the second precision matrix to compute the anomaly sore. The approach used in embodiments of the invention can bypass the above-described limitations of known deep feature approaches because embodiments of the invention do not change the input format but change the parameters in the computation of the anomaly prediction, i.e., a summation of the first SD mean vector and the second SD mean vector, along with a summation of the first SD precision matrix and the second SD precision matrix, where the first and second SDs are different from one another.

In addition to one or more of the features described above, or as an alternative to any of the foregoing embodiments of the invention, the first summation includes a first weighted summation; and the second summation includes a second weighted summation.

The above-described embodiments of the invention provide technical benefits and technical effects. While known deep feature approaches do not allow the TD domain vector to be input into their computation of anomaly prediction, i.e., the computation of the Mahalanobis distance, as an additional input because the input format is fixed in known deep feature approaches, embodiments of the invention use a first weighted summation that includes a weighted summation of the first SD mean vector and the second SD mean vector, along with a second weighted summation that includes a weighted summation of the first SD precision matrix and the second precision matrix to compute the anomaly sore. The approach used in embodiments of the invention can bypass the above-described limitations of known deep feature approaches because embodiments of the invention do not change the input format but change the parameters in the computation of the anomaly prediction, i.e., a weighted summation of the first SD mean vector and the second SD mean vector, along with a weighted summation of the first SD precision matrix and the second SD precision matrix, where the first and second SDs are different from one another.

In addition to one or more of the features described above, or as an alternative to any of the foregoing embodiments of the invention, learning to predict the anomaly is based at least in part on a TD domain vector of the TD; a weight component of the first weighted summation includes the TD domain vector; a weight component of the second weighted summation includes the TD domain vector; and learning to predict the anomaly includes computing a Mahalanobis distance based at least in part on the TD domain vector, the first weighted summation, and the second weighted summation.

The above-described embodiments of the invention provide technical benefits and technical effects. While known deep feature approaches do not allow the TD domain vector to be input into their computation of anomaly prediction, i.e., the computation of the Mahalanobis distance, as an additional input because the input format is fixed in known deep feature approaches, embodiments of the invention use a first weighted summation that includes a weighted summation of the first SD mean vector and the second SD mean vector, along with a second weighted summation that includes a weighted summation of the first SD precision matrix and the second precision matrix to compute the anomaly sore, where the weight is provided by the TD domain vector. The approach used in embodiments of the invention can bypass the above-described limitations of known deep feature approaches because embodiments of the invention do not change the input format but change the parameters in the computation of the anomaly prediction, i.e., a weighted summation of the first SD mean vector and the second SD mean vector, along with a weighted summation of the first SD precision matrix and the second SD precision matrix, where the weight is provided by the TD domain vector, and where the first and second SDs are different from one another.

Embodiments of the invention are also directed to computer-implemented methods and computer program products having substantially the same features, functionality, and technical benefits as the computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2 depicts a simplified block diagram illustrating a system architecture embodying aspects of the invention;

FIG. 3A depicts a simplified block diagram illustrating a model of a biological neuron operable to be utilized in neural network architectures in accordance with aspects of the invention;

FIG. 3B depicts a simplified block diagram illustrating a deep learning neural network architecture in accordance with aspects of the invention;

FIG. 4 depicts a flow diagram illustrating a computer-implemented methodology according to aspects of the invention;

FIG. 5 depicts non-limiting examples of how to implement anomaly detection operations in accordance with aspects of the invention;

FIG. 6 depicts a simplified block diagram illustrating a non-limiting example of how aspects of the system architecture shown in FIG. 1 can be implemented in accordance with aspects of the invention; and

FIG. 7 depicts a diagram illustrating non-limiting examples of target domain (TD) images and source domain (SD) images that can utilize the system architecture shown in FIG. 1 in accordance with aspects of the invention.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components/modules of the systems illustrated herein are depicted separately for ease of illustration and explanation. In embodiments of the invention, the functions performed by the various components/modules can be distributed differently than shown without departing from the scope of the various embodiments of the invention describe herein unless it is specifically stated otherwise.

Turning now to an overview of technologies that are more specifically related to aspects of the invention, as previously noted herein, anomaly detection is the process of detecting anomalies, and, depending on the goals of the associated data analysis, remove or resolve them from the analysis to prevent any potential skewing. Anomaly detection tasks can be performed by neural networks using deep learning algorithms. Known deep learning algorithms require large amounts of labeled (annotated) data to learn so-called “deep features” in order to train effective models for the performance of cognitive operations such as prediction, classification, and the like. However, in many anomaly detection deep learning applications, labeled anomalous training data is not available or not abundant due to a variety of factors.

So-called “zero-shot” learning techniques have been developed to train machine learning algorithms to perform classification or prediction tasks where the machine learning algorithm has not previously seen or been trained with examples of the actual classification/prediction task. Another machine learning technique for performing zero-shot learning is known as “transfer learning.” Transfer learning is a machine learning method where a model developed for a first task is reused as the starting point for a model on a second, different but related task. The domain of the to-be-predicted (TBP) data is referred to as the target domain (TD), and the domain of the different but related task is referred to as the source domain (SD).

It is a challenge in known zero-shot deep learning techniques that implement transfer learning to identify the deep features of the TD in a manner that enables the SD training data to train the TD anomaly detection model in an efficient and effective manner. Accordingly, there is a need in the art of anomaly detection to develop processes for identifying deep features of the TD in manner that enables zero-shot deep learning processes and transfer learning processes to efficiently and effectively leverage SD training data to develop TD anomaly detection models.

Turning now to an overview of aspects of the invention, embodiments of the invention provide computing systems, computer-implemented methods, and computer program products that implement a novel transfer learning scheme operable to generate a TD anomaly detection model using SD data. In some embodiments of the invention, the computer-implemented method calculates an anomaly score for a TD image. The method includes obtaining a TD domain vector representing characteristics of the TD. The TD domain vectors are latent domain vectors, which are latent representations of the TD domains. A weighted-sum SD mean vector is computed from latent features of each instance of a SD in the set of SDs by computing a SD mean vector for each of the SDs; applying the TD domain vector as a weight to each instance of a SD in the set of SDs; and summing the weighted SD mean vectors to create the weighted-sum SD mean vector. A weighted-sum SD precision matrix is computed from latent features of each instance of a SD in the set of SDs; applying the TD domain vector as a weight to each instance of a SD in the set of SDs; and summing the weighted SD precision matrices to create the weighted-sum SD precision matrix. A Mahalanobis distance is computed in accordance with embodiments of the invention based at least in part on the TD domain vector, the weighted sum of SD mean vectors, and the weighted sum precision matrices. In general, a Mahalanobis distance is a multivariate distance metric that measures the distance between a point and a distribution. The Mahalanobis distance is a metric that can be used to identify multivariate anomalies or outliers. The larger the value of Mahalanobis distance, the more unusual the data point (i.e., the more likely it is to be a multivariate anomaly/outlier). In accordance with embodiments of the invention, known Mahalanobis distance computations are modified to take into account the TD domain vector, the weighted sum of SD mean vectors, and the weighted sum of precision matrices.

In some embodiments of the invention, the mean vector and precision matrix in each SD are the sample mean vector and precision matrix of the latent features in each SD. The sample mean vector is the mean of latent feature vectors of image samples in the training data, where latent feature vectors can be computed with the “EfficientNet” or other similar image models.

In some embodiments of the invention, the domain vector is computed from deep sets or its variants from latent features. The prediction model is trained for the weights for the weighted sum with deep sets in order to make predicted weights domain-specific in the SD. Specifically, embodiments of the invention consider one domain in the SD as the pseudo-TD in training, and in round robin manner, the deep sets are trained to produce domain-specific weight vectors for the pseudo-TD. The pseudo-TD is an SD selected in the current step of the round robin, which corresponds to an iteration step of the gradient descent in the optimization of the prediction model.

In some embodiments of the invention, once the model is trained properly, the prediction for the weights can be generalized even for the unseen TD.

In some embodiments of the invention, mean vectors and precision matrices are computed for each small patch in an image and a local anomaly detection result is computed for each patch.

In some embodiments of the invention, the deep sets are used to predict a single set of coefficients (single domain vector) for all domains, and the same coefficients are used over all patches in an image in a domain.

In some embodiments of the invention, deep sets are also predict a domain vector for each patch in a domain

In some embodiments of the invention, a single anomaly detection result is computed as the maximum, average, or weighted sum of the previously-described local anomaly detection results.

In some embodiments of the invention, data on each domain is augmented into different domain data. This feature enables embodiments of the invention to be used when we have only a single SD.

In some embodiments of the invention, the domain vector is calculated from deep sets or its variants from latent features of images in the TD.

In some embodiments of the invention, the SD mean vectors and the SD precision matrices are computed for each small patch in an image and a local anomaly detection result is computed for each patch. A single anomaly detection result is calculated as the maximum, average, or weighted sum of local anomaly detection results.

In some embodiment of the invention, the anomaly score is a log-likelihood with the SD mean vector and SD precision matrix. The log-likelihood value is a measure of goodness of fit for any model where a higher value represents a better model performance. A monotonically increasing function can be used for wrapping the score.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

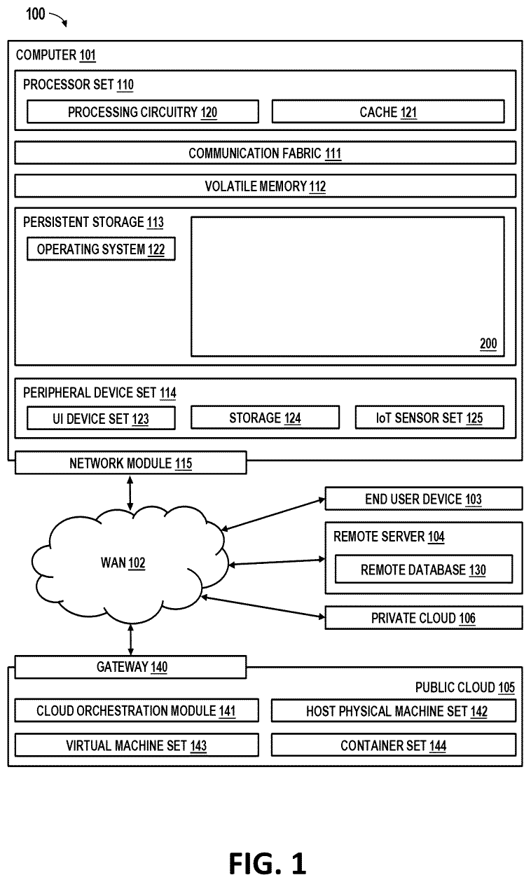

FIG. 1 depicts a computing environment 100 that contains an example of an environment for the execution of at least some of the computer code involved in performing the inventive methods, such as code block 200 operable to implement a transfer learning scheme to generate a target domain anomaly detection model using source domain data. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

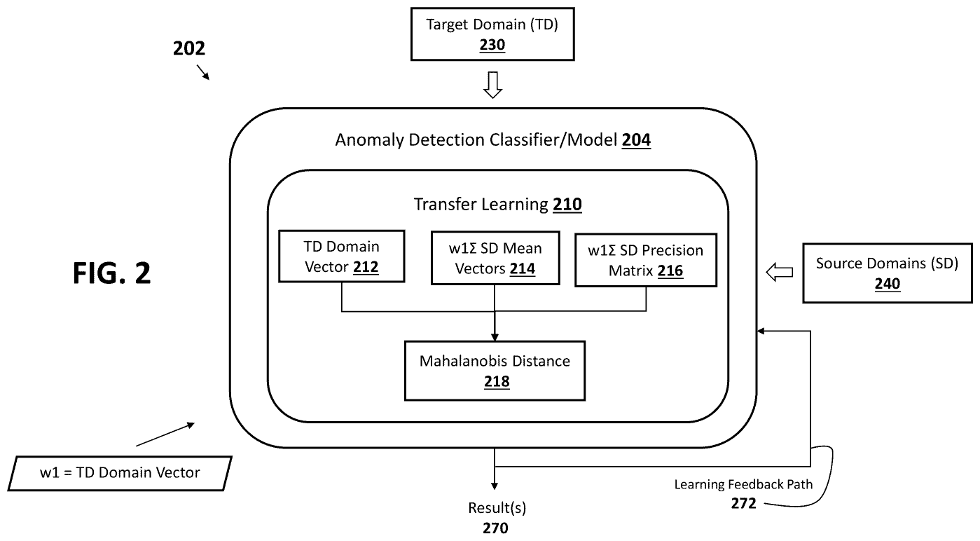

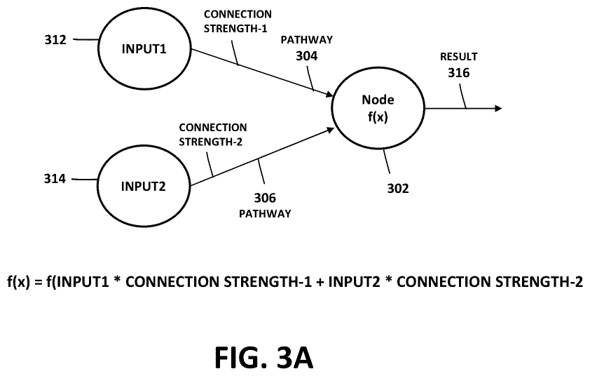

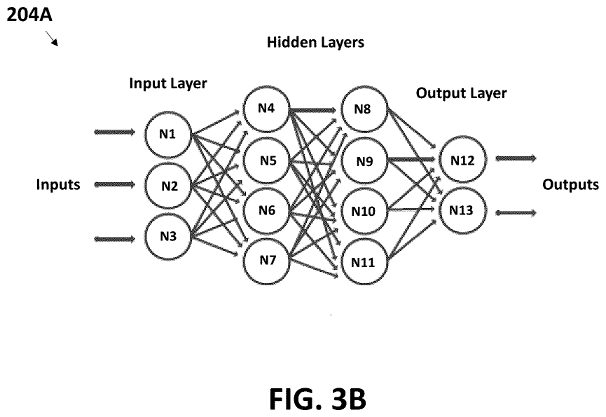

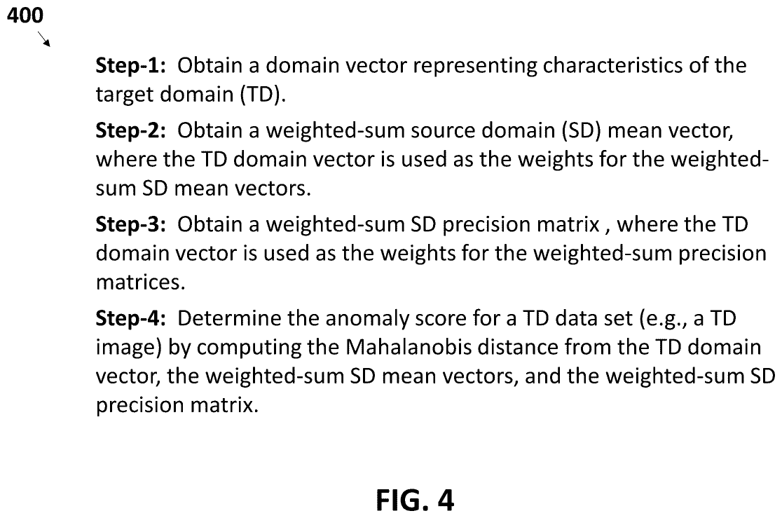

FIG. 2 depicts a simplified block diagram illustrating a system 202 operable to implement embodiments of the invention. FIGS. 3A and 3B depict non-limiting examples of how the anomaly detection classifier/model 204 of the system 202 shown in FIG. 1 can be implemented as a deep learning algorithm 204A. FIG. 4 depicts a flow diagram illustrating a computer-implemented methodology 400 operable to be performed by the system 202 according to aspects of the invention. The following description of the system 202 refers to components and operations of the system 202 shown in FIG. 2, and, where appropriate, also refers to the corresponding features, operations, and/or steps of the deep learning algorithm 204A shown in FIG. 3B and the methodology 400 shown in FIG. 4.

The system 202 includes an anomaly detection classifier/model 204, which can be implemented at least in part as the deep learning algorithm 204A (shown in FIG. 3B). As shown in FIG. 3A, the deep learning algorithm 204A is based on the functionality a biological neuron, which is modeled in FIG. 3A a node operable to implement a mathematical function (f(x)). In general, a biological neuron has pathways that connect it to upstream inputs, downstream outputs, and downstream “other” neurons. Each biological neuron sends and receives electrical impulses through the pathways. The nature of these electrical impulses and how they are processed in biological neuron are primarily responsible for overall brain functionality. The pathway connections between the biological neurons can be strong or weak. When the neuron receives input impulses, the neuron processes the input according to the neuron's function and sends the result of the function on one of the pathways to downstream outputs and/or another one of the pathways to downstream “other” neurons. A normal adult human brain includes about one hundred billion interconnected neurons.

In FIG. 3A, the biological neuron is modeled as the node 302 having the mathematical function, f(x), which is depicted by the equation shown in FIG. 3A. Node 302 receives electrical signals from inputs 312, 314, multiplies each input 312, 314 by the strength of its respective connection pathway 304, 306, takes a sum of the inputs, passes the sum through the function, f(x), and generates a result 316, which can be a final output or an input to another node, or both. In the present specification, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 3B depicts a simplified example of a deep learning neural network architecture (or model) 204A. In general, neural networks can be implemented as a set of algorithms running on a programmable computer (e.g., computing environment 100 shown in FIG. 1). In some instances, neural networks are implemented on an electronic neuromorphic machine (e.g., the IBM®/DARPA SYNAPSE computer chip) that attempts to create connections between processing elements that are substantially the functional equivalent of the synapse connections between brain neurons. In either implementation, neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a neural network is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The neural network is “trained” by performing multiple iterations of learning-based analysis on the real-world data vectors until patterns (or relationships) contained in the real-world data vectors are uncovered and learned.

Neural networks use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a neural network can be used to perform a variety of tasks, two of the more common tasks are labeling (or classification) of real-world data and determining the similarity between segments of real-world data. Classification tasks often depend on the use of labeled datasets to train the neural network to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, the like. Similarity tasks apply similarity techniques and (optionally) confidence levels (CLs) to determine a numerical representation of the similarity between a pair of items.

Returning still to FIG. 3B, the simplified neural network architecture/model 204A is organized as a weighted directed graph, where the artificial neurons are nodes (e.g., N1-N13), and where weighted directed edges (i.e., the directional arrows) connect the nodes. The neural network architecture/model 204A is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. Multiple hidden layers indicates that the neural network architecture/model 204A is a deep learning neural network architecture/model. Each node is connected to every node in the adjacent layer by connection pathways, which are depicted in FIG. 3B as directional arrows each having its own connection strength. For ease of illustration and explanation, one input layer, two hidden layers, and one output layer are shown in FIG. 3B. However, in practice, multiple input layers, multiple hidden layers, and multiple output layers can be provided. When multiple hidden layers are provided, the neural network model 204A can perform unsupervised deep-learning for executing classification/similarity type tasks.

Similar to the functionality of a human brain, each input layer node N1, N2, N3 of the neural network 204A receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathways into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The neural network architecture/model 204A can implement various deep learning-based feature extraction and classification methods. In general, deep learning-based classification schemes have two sub-networks, a feature extraction network followed by a classification sub-network that are learned jointly during training. Traditional non-zero-shot deep learning requires the availability of multiple classes for training and an extremely large number of training samples (in the order of thousands or millions). However, for zero-shot learning performed by the neural network architecture/model 204A, the classes covered by training instances and the classes that the classification/prediction task needs to classify are disjoint. Thus, zero-shot learning techniques are designed to overcome the lack of training examples in the classification/prediction task by leveraging details learned from training examples of a task that is related to but different from the subject classification/prediction task. The details learned from training examples of the related/different task are used to draw inferences about the unknown classes of the subject classification/prediction task because both the training classes and the unknown task classes are related in a high dimensional vector space called semantic space. Thus, zero-shot learning techniques performed by the neural network architecture/model 204A can include a training stage and an inference stage. In the training stage, knowledge about the attributes of intermediate semantic layers is captured; and in the inference stage, this knowledge is used to categorize instances among a new set of classes.

Returning now to the system 202 shown in FIG. 2, the anomaly detection classifier/model 204 is operable to perform zero-shot transfer learning in which training data from a SD 240 is used to train the classifier/model 204 to perform a classification task on TBP data from the TD 230. The transfer learning module 210 is operable to assist with training the deep learning algorithms of the classifier/model 204. In general, the transfer learning module 210 is operable to perform transfer learning tasks that leverage model parameters (e.g., labeled data and associated data formats/structures) that are ideal for one task (e.g., detecting and classifying anomaly data of the SD 240) and using it instead as part of the development of another task (e.g., detecting and classifying anomaly data of the TD 230).

The anomaly detection functionality performed by the classifier/model 204 and the transfer learning module 210 can, in some embodiments of the invention, use an autoencoder architecture, which is a type of neural network that learns how to efficiently compress and encode original data to a lower dimensional space known as “latent code” then learns how to decompress the latent code to a representation of the original data (i.e., “reconstructed” original data) that is as close to the original data input as possible. The differences between the original data input and the reconstructed data output can be used to create encoded rules for expected output and vice versa. Post-training, the autoencoder can flag as anomalous data values that fall outside of the encoded rules.

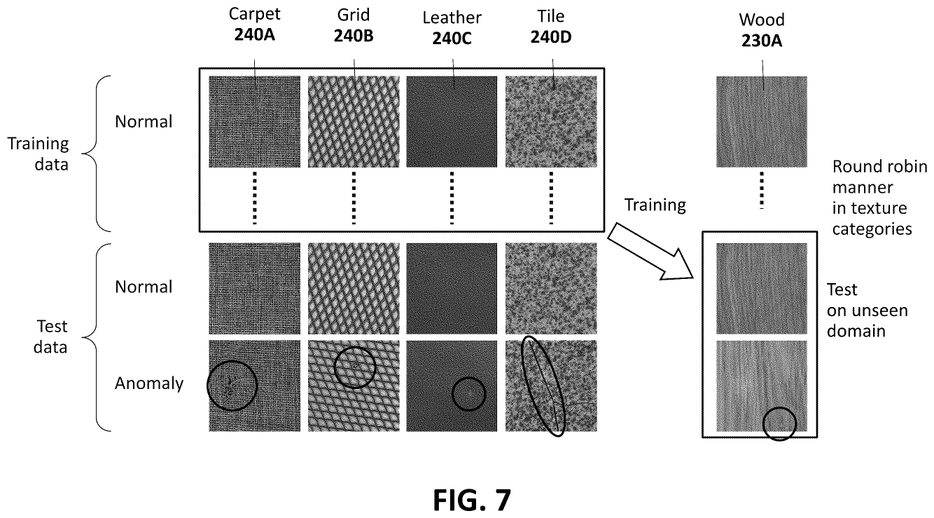

In embodiments of the invention, the anomaly detection classifier/model 204 is operable to interface with and receive data from a TD 230 and a SD 240. Example implementations of the TD 230 and the SD 240 are shown in FIG. 7, which shows example images of different types of surfaces or surface textures. The wood surface images 230A are example implementations of the TD 230. The carpet surface images 240A, the grid surface images 240B, the leather surface images 240C, and the tile surface images 240D are example implementations of the SD 240. In embodiments of the invention, the TD 230 and the SDs 240 can each be a repository of electronic files containing electronic image data representing multiple instances of the wood surface images 230A, the carpet surface images 240A, the grid surface images 240B, the leather surface images 240C, and the tile surface images 240D that can be accessed by the anomaly detection classifier/model 204, and converted to a format or formats that can be analyzed by the various neural networks of the classifier/model 204.

As shown in FIG. 7, the training data includes normal or non-anomalous instances of the wood surface images 230A, the carpet surface images 240A, the grid surface images 240B, the leather surface images 240C, and the tile surface images 240D. The test data includes normal and anomaly instances of the wood surface images 230A, the carpet surface images 240A, the grid surface images 240B, the leather surface images 240C, and the tile surface images 240D. In general, the training data varies depending on whether we are using the classifier/model 204 uses supervised learning algorithms (the image files of the SD 240 are labeled) or unsupervised learning algorithms (the image files of the SD 240 are not labeled. For unsupervised learning, the training data contains unlabeled TD and SD data points, i.e., inputs are not tagged with the corresponding outputs. The classifier/model 204 is required to find the patterns from the given training datasets in order to make predictions. On the other hand, for supervised learning. the classifier/model 204 learns to make predictions based on training data that contains labels for the SD data points, while the TD data points remain unlabeled.

Once the classifier/model 204 is trained with the training dataset, the classifier/model 204 is tested with the test dataset. The test dataset evaluates the performance of the classifier/model 204 and ensures that the classifier/model 204 can generalize well with a new or unseen dataset from the TD 230. The test dataset is used as a benchmark for model evaluation once the model training is completed. The test data contains data for each type of scenario for a given problem that the classifier/model 204 would be facing when used in the real world. Accordingly, the test data includes normal instances and anomaly instances of image files of the SD images 240A, 240B, 240C, 240D, along with normal instances and anomaly instance of image files containing the TD image 230A.

Returning again to the system 202 shown in FIG. 2. the TD data from the TD 230 and the SD data from the SD 240 are transformed or encoded into numbers, including vectors and matrices. The classifier/model 204 use the encoded vectors and matrices to determine TD domain vectors 212, weighted-sum SD mean vectors 214, and weighted-sum SD precision matrices 216. In general, vectors and matrices represent inputs like text and images as numbers, which can be read, understood and processed by the classifier/model 204 during training, testing, and post-training/testing predictions. Vectors can be related to domain features, and the various domain features, including the latent domain features, can be represented as vectors. The latent domain features include multivariates from which mean vectors and precision matrices can be computed. In general, a multivariate is a vector each of whose elements is a variate. The variates need not be independent, and if they are not, a correlation is said to exist between them. The term “multivariate” is also used as an adjective to mean involving many variables, as opposed to one (univariate) or two (bivariate). The mean vector of the multivariate representations of the latent domain features can be computed as the means of each variable of the multivariate representations of the latent domain features. A precision matrix (also known as an inverse covariance matrix) represents the pair-wise correlations between variables in a multivariate normal distribution. The matrix's entries represent the degree to which changes in one variable are related to changes in another. The precision matrix's diagonal entries are the reciprocals of the variances of the individual variables, and the off-diagonal entries are the covariances between the variables. The precision matrix has the benefit of being easier to explain in terms of conditional independence than the covariance matrix. If two variables are independent, the precision matrix entry corresponding to them is zero. If two variables are significantly reliant on each other, the corresponding entry in the precision matrix represents the degree to which changes in one variable are related to changes in another. As a result, the precision matrix is a more straightforward method of assessing conditional independence than the covariance matrix. Thus, the precision matrix conveys how strongly one variable is reliant on others, which can help assist with comprehending conditional independence and other multivariate distribution features.

The transfer learning module 210 implements learning/training processes for identifying deep features of the TD 230 in a manner that enables zero-shot deep learning processes of the classifier/model 204 and the transfer learning module 210 to efficiently and effectively leverage SD training data of the SD 240 to develop or train the classifier/model 204 to identify anomaly data (e.g., included among the results 270) in the TD 230. The transfer learning module 210 identifies deep features of the TD 230 by using a set of TD domain vectors 212 (Step-1 of the methodology 400 shown in FIG. 4), weighted sum SD mean vectors 214 (Step-2 of the methodology 400 shown in FIG. 4), and weighted sum precision matrices 216 (Step-3 of the methodology 400 shown in FIG. 4) to computer the Mahalanobis distance 218 (Step-4 of the methodology 400 shown in FIG. 4), which is used to generate results 270 as an anomaly prediction. In embodiments of the invention, the TD domain vectors 212 are used as the weights that are used to form the weighted sum SD mean vectors 214 (Step-2 of the methodology 400 shown in FIG. 4), and the TD domain vectors 212 are used as the weights that are used to form the weighted sum precision matrices 216 (Step-3 of the methodology 400 shown in FIG. 4). In embodiments of the invention, the results 270 can also branch through a learning feedback path 272 to provide further training of the classifier/model 204.

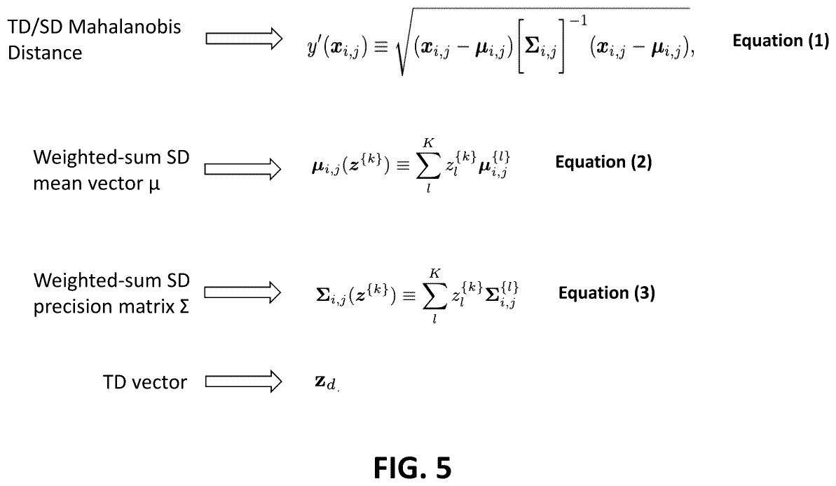

The TD domain vectors 212 are latent domain vectors, which are latent representations of the TD 230. Latent representations can be generated through a process known as latent representation learning (LRL) or latent variable modeling (LVM). LRL is a machine learning technique that attempts to infer latent variables from empirical measurements. Latent variables are variables that cannot be measured directly and therefore have to be inferred from the empirical measurements. In a given domain, some variables of interest are directly measurable variables, while some variables of interest are not directly measurable. Such not-directly-measurable variables are modeled as latent variables of an LVM. In general, one or many latent variables jointly constitute a latent space or latent representation. This representation is usually a compressed form of the empirical measurements; it consists of fewer latent variables than the dimensionality of the measurements (i.e., the number of different measurement modalities). The latent domain vectors (i.e., the TD domain vector 212) are used in embodiments of the invention to infer anomaly-related features of the TD 230 from the set of normal instances in the TD 230. The TD mean vector 212 is represented in FIG. 5 as “z_{d}.”

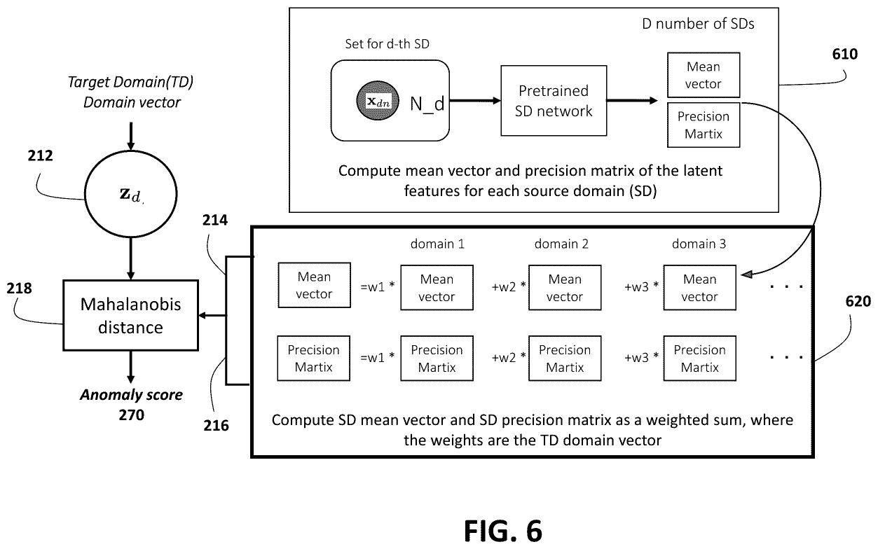

The weighted-sum SD mean vector 214 is computed in accordance with the previously-described mean vector computations applied to latent features of each instance of a SD in the set of SDs. Using the example shown in FIG. 7, a first SD mean vector would be computed for the carpet surface images 240A; a second S/D mean vector would be computed for the grid surface images 240B; a third S/D mean vector would be computed for the leather surface images 240C; and a fourth S/D mean vector would be computed for the tile surface images 240D. The TD domain vector 212 is applied as a weight to each of the first SD mean vector, the second SD mean vector, the third SD mean vector, and the fourth SD mean vector. The weighted first, second, third, and fourth SD mean vectors are summed to create the weighted-sum SD mean vector 214. A non-limiting example of how the weighted-sum SD mean vector 214 can be computed using Equation (2) shown in FIG. 5. Additionally, FIG. 6 depicts at block 610 a non-limiting example of an architecture for computing the SD mean vector, and further depicts at block 620 a non-limiting example of an architecture for applying the TD domain vector 212 as weights to the SD mean vectors for each SD to generate the weighted-sum SD mean vector 214. X_{dn} is an n-th image sample in the d-th domain.

The weighted-sum SD precision matrix 216 is computed in accordance with the previously-described precision matrix computations applied to latent features of each instance of a SD in the set of SDs. Using the example shown in FIG. 7, a first SD precision matrix would be computed for the carpet surface images 240A; a second S/D precision matrix would be computed for the grid surface images 240B; a third S/D precision matrix would be computed for the leather surface images 240C; and a fourth S/D precision matrix would be computed for the tile surface images 240D. The TD domain vector 212 is applied as a weight to each of the first SD precision matrix, the second SD precision matrix, the third SD precision matrix, and the fourth SD precision matrix. The weighted first, second, third, and fourth SD precision matrices are summed to create the weighted-sum SD precision matrix 216. A non-limiting example of how the weighted-sum SD precision vector 216 can be computed using Equation (3) shown in FIG. 5. Additionally, FIG. 6 depicts at block 610 a non-limiting example of an architecture for computing the SD precision matrix, and further depicts at block 620 a non-limiting example of an architecture for applying the TD domain vector 212 as weights to the SD precision matrix for each SD to generate the weighted-sum SD precision matrix vector 216. X_{dn} is a n-th image sample in the d-th domain.

The Mahalanobis distance 218 is computed based at least in part on the TD domain vector 212, the weighted sum of SD mean vectors 214, and the weighted sum precision matrices 216. In general, a Mahalanobis distance is a multivariate distance metric that measures the distance between a point and a distribution. The Mahalanobis distance is a metric that can be used to identify multivariate anomalies or outliers. The larger the value of Mahalanobis distance, the more unusual the data point (i.e., the more likely it is to be a multivariate anomaly/outlier). In accordance with embodiments, known Mahalanobis distance computations are modified to take into account the TD domain vector 212, the weighted sum of SD mean vectors 214, and the weighted sum precision matrices 216. A non-limiting example of how the Mahalanobis distance 218 can be computed in accordance with embodiments of the invention to take into account the TD domain vector 212, the weighted sum SD mean vectors 214, and the weighted sum precision matrices 216 is depicted as Equation (1) shown in FIG. 5. Xᵢⱼ is a latent image feature at (i, j) position in the n-th image sample in the d-th domain, where indices n and d are omitted.

Thus, it can be seen from the foregoing detailed description that embodiments of the invention provide technical effects and benefits. While known deep feature approaches do not allow the TD domain vector to be input into their computation of anomaly prediction, i.e., the computation of the Mahalanobis distance, as an additional input because the input format is fixed in known deep feature approaches, embodiments of the invention use a weighted-sum SD mean vector and a weighted-sum SD precision matrices to compute the Mahalanobis distance. The approach used in embodiments of the invention can bypass the above-described limitations of known deep feature approaches because embodiments of the invention do not change the input format but change the parameters in the computation of the Mahalanobis distance, i.e., the mean vector and the precision matrix, with the weighted-sums.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the

future, may make various improvements and enhancements which fall within the scope of the claims which follow.

What is claimed is:

1. A computer system comprising a memory communicatively coupled to a processor system, wherein the processor system is operable to perform processor system operations to predict an anomaly in a target domain (TD) dataset, the processor system operations comprising:
training a model to perform an anomaly prediction task on a TD;
wherein the training includes applying a transfer learning operation that includes learning to predict the anomaly based at least in part on a first source domain (SD) precision matrix computed from a first SD.

2. The computer system of claim 1, wherein learning to predict the anomaly is further based at least in part on a second SD precision matrix computed from a second SD that is different from the first SD.

3. The computer system of claim 2, wherein learning to predict the anomaly is further based at least in part on a first SD mean vector computed from the first SD.

4. The computer system of claim 3, wherein learning to predict the anomaly is further based at least in part on a second SD mean vector computed from the second SD.

5. The computer system of claim 4, wherein learning to predict the anomaly is further based at least in part on:
a first summation comprising a summation of the first SD precision matrix and the second SD precision matrix; and
a second summation comprising a summation of the first SD mean vector and the second SD mean vector.

6. The computer system of claim 5, wherein:
the first summation comprises a first weighted summation; and
the second summation comprises a second weighted summation.

7. The computer system of claim 6, wherein:
learning to predict the anomaly is based at least in part on a TD domain vector of the TD;
a weight component of the first weighted summation comprises the TD domain vector;
a weight component of the second weighted summation comprises the TD domain vector; and
learning to predict the anomaly comprises computing a Mahalanobis distance based at least in part on the TD domain vector, the first weighted summation, and the second weighted summation.

8. A computer-implemented method operable to use a processor system to perform processor system operations to predict an anomaly in a target domain (TD) dataset, the processor system operations comprising:
training a model to perform an anomaly prediction task on a TD;
wherein the training includes applying a transfer learning operation that includes learning to predict the anomaly based at least in part on a first source domain (SD) precision matrix computed from a first SD.

9. The computer-implemented method of claim 8, wherein learning to predict the anomaly is further based at least in part on a second SD precision matrix computed from a second SD that is different from the first SD.

10. The computer-implemented method of claim 9, wherein learning to predict the anomaly is further based at least in part on a first SD mean vector computed from the first SD.

11. The computer-implemented method of claim 10, wherein learning to predict the anomaly is further based at least in part on a second SD mean vector computed from the second SD.

12. The computer-implemented method of claim 11, wherein learning to predict the anomaly is further based at least in part on:
a first summation comprising a summation of the first SD precision matrix and the second SD precision matrix; and
a second summation comprising a summation of the first SD mean vector and the second SD mean vector.

13. The computer-implemented method of claim 12, wherein:
the first summation comprises a first weighted summation; and
a second summation comprising a second weighted summation.

14. The computer-implemented method of claim 13, wherein:
learning to predict the anomaly is based at least in part on a TD domain vector of the TD;
a weight component of the first weighted summation comprises the TD domain vector;
a weight component of the second weighted summation comprises the TD domain vector; and
learning to predict the anomaly comprises computing a Mahalanobis distance based at least in part on the TD domain vector, the first weighted summation, and the second weighted summation.

15. A computer program product comprising a computer readable program stored on a computer readable storage medium, wherein the computer readable program, when executed on a processor system, causes the processor to perform processor system operations comprising:
training a model to perform an anomaly prediction task on a TD;
wherein the training includes applying a transfer learning operation that includes learning to predict the anomaly based at least in part on a first source domain (SD) precision matrix computed from a first SD.

16. The computer program product of claim 15, wherein learning to predict the anomaly is further based at least in part on a second SD precision matrix computed from a second SD that is different from the first SD.

17. The computer program product of claim 16, wherein learning to predict the anomaly is further based at least in part on:
a first SD mean vector computed from the first SD; and
a second SD mean vector computed from the second SD.

18. The computer program product of claim 17, wherein learning to predict the anomaly is further based at least in part on:
a first summation comprising a summation of the first SD precision matrix and the second SD precision matrix; and
a second summation comprising a summation of the first SD mean vector and the second SD mean vector.

19. The computer program product of claim 18, wherein:
the first summation comprises a first weighted summation; and
a second summation comprising a second weighted summation.

20. The computer program product of claim 19, wherein:
learning to predict the anomaly is based at least in part on a TD domain vector of the TD;
a weight component of the first weighted summation comprises the TD domain vector;
a weight component of the second weighted summation comprises the TD domain vector; and
learning to predict the anomaly comprises computing a Mahalanobis distance based at least in part on the TD domain vector, the first weighted summation, and the second weighted summation.
